(19) United States
(12) Patent Application Publication
(10) Pub. No.: US 2013/0139222 A1
(43) Pub. Date: May 30, 2013

(54) AUTHENTICATION OF MOBILE DEVICE

(71) Applicants: Viacheslav Kirillin, St. Petersburg (RU); Sergey Zemlyanskiy, St. Petersburg (RU)

(72) Inventors: Viacheslav Kirillin, St. Petersburg (RU); Sergey Zemlyanskiy, St. Petersburg (RU)

(73) Assignee: RAWLLIN INTERNATIONAL INC.

(21) Appl. No.: 13/306,538

(22) Filed: Nov. 29, 2011

(51) Int. Cl. H04L 29/06; H04L 9/00; H04L 9/32

(52) U.S. Cl. 726/4; 726/6

(57) ABSTRACT

Disclosed are systems and techniques that generate one-time passwords in a banking server in order to authenticate a mobile device for transactional functions related to a user account. At least two one-time passwords are generated at the banking server and communicated to the mobile device via different communication pathways. A first communication pathway is encrypted and a second pathway is non-encrypted.

### TECHNICAL FIELD

The subject application relates generally to the field of authentication of mobile devices, and more particularly to methods and systems for authenticating a host device or system with a network server.

### BACKGROUND

Significant legal and technical challenges exists with respect to protection of customer information, increasing incidents of fraud in banking sectors such as identity theft, and the introduction of authentication technologies. Banks are recommended to conduct risk-based assessments, evaluate customer awareness programs, and develop security measures to reliably authenticate customers remotely accessing their internet-based financial services.

Agencies consider single-factor authentication, as the only control mechanism, to be inadequate for high-risk transactions involving access to customer information or the movement of funds to other parties. Financial institutions offering Internet-based products and services to their customers should use effective methods to authenticate the identity of customers using those products and services. The authentication techniques employed by the financial institution should be appropriate to the risks associated with those products and services. Account fraud and identity theft are frequently the result of single-factor (e.g., ID/password) authentication exploitation. Where risk assessments indicate that the use of single-factor authentication is inadequate, financial institutions should implement multifactor authentication, layered security, or other controls reasonably calculated to mitigate those risks.

There are a variety of technologies and methodologies financial institutions can use to authenticate customers. These methods include the use of customer passwords, personal identification numbers (PINs), digital certificates using a public key infrastructure (PKI), physical devices such as smart cards, one-time passwords (OTPs), USB plug-ins or other types of “tokens”, transaction profile scripts, biometric identification, and others. The level of risk protection afforded by each of these techniques varies.

With the growth in electronic banking and commerce, financial institutions should use reliable methods of originating new customer accounts online. Moreover, customer identity verification during account origination is required by section by some law and is important in reducing the risk of identity theft, fraudulent account applications, and unenforceable account agreements or transactions. Potentially significant risks arise when a financial institution accepts new customers through the Internet or other electronic channels.

The above-described challenges of today's banking sectors lend for the need to better serve clients by providing better authentication security for the clients and mobile devices, in which the client transacts with. The above deficiencies are merely intended to provide an overview of some of the problems of conventional systems, and are not intended to be exhaustive. Other problems with conventional systems and corresponding benefits of the various non-limiting embodiments described herein may become further apparent upon review of the following description

### SUMMARY

The following presents a simplified summary in order to provide a basic understanding of some aspects disclosed herein. This summary is not an extensive overview. It is intended to neither identify key or critical elements nor delineate the scope of the aspects disclosed. Its sole purpose is to present some concepts in a simplified form as a prelude to the more detailed description that is presented later.

Various embodiments for authenticating mobile devices for transactional functions on a banking server are contained herein. An exemplary system comprises a banking server that includes a customer financial database having financial information related to one or more user accounts. The system also comprises a one-time password generator operatively coupled to the banking server that is configured to generate one-time passwords, receive control commands from the banking server, and generate a first one-time password and a second one-time password in response to the control commands. The banking server is configured to communicate the first one-time password over a first communication pathway to a web browser of a mobile device of a user and communicate the second one-time password according to a different communication protocol over a second communication pathway to the mobile device of the user.

In still another non-limiting embodiment, an exemplary method for authenticating a mobile device comprises hosting a financial database with a banking server that stores financial information related to one or more user accounts. The method includes receiving, at a banking server that stores financial information related to one or more user accounts, a log-in request from a device of a user with at least one user account of the one or more user accounts. The method includes generating at least two one-time passwords in response to the log-in request, communicating respective one-time passwords of the at least two one-time passwords in different respective communication modes to the user, and validating the device of the user including authenticating the at least two one-time passwords and providing access to transaction functions related to the at least one user account of the user.

In still yet another non-limiting embodiment, an exemplary computer readable storage medium having computer executable instructions that, in response to execution by a computing system, cause the computing system to perform operations that comprise receiving a log-in request from a mobile device of a user for at least one user account of one or more user accounts at a banking server to access transactional functions related to the at least one user account of the one or more user accounts, generating a first one-time password and a second one-time password at the banking server in response to the log-in request, and communicating the first one-time password in a first encrypted communication and the second one-time password in a second non-encrypted communication to a mobile device of the user. The operations further include determining whether to grant an authorization for the user at a log-in screen generated by the banking server on the mobile device including comparing the first one-time password with an input received from the user at the log-in screen, and authenticating the mobile device to access the transactional functions related to the at least one user account in response to the authorization being granted.

In still yet another non-limiting embodiment, an exemplary system comprises means for hosting a banking server with a financial database, means for receiving a log-in request by a banking server that stores financial information related to one or more user accounts, means for generating at least two one-time passwords and communicating each of the at least two one-time passwords in a different communication protocol to a mobile phone of a user, and means for authenticating the mobile phone to access transactional functions related to at least one user account of the one or more user accounts by receiving an input from the user having the second one-time password.

In still yet another embodiment, a method for a mobile device is disclosed that comprises generating a log-in request, by the mobile device, to access at least one user account of one or more user accounts of a banking server and to access transactional functions related to at least one user account of the one or more user accounts. In response to the log-in request, the mobile phone receives a first one-time password at a web browser component of the mobile device in a first encrypted communication and receives a second one-time password at a messaging service of the mobile device in a second non-encrypted communication. The method further comprises determining whether to grant an authorization for the user at a log-in screen including comparing the first one-time password with an input received from the user at the log-in screen, and accessing the transactional functions related to the at least one user account in response to the authorization granted based on the input.

In yet another exemplary embodiment, a mobile device comprises an interface component configured to receive trigger data that triggers generation or retrieval of a first one-time password and a second one-time password. A display component is configured to display information received from a banking server and a one-time password generator. A web browser component is configured to receive the first one-time password in response to the trigger data. A text component is configured to receive the second one-time password in response to the trigger data. The display component is configured to receive an input from a user of the mobile device, and wherein the interface component is configured to communicate the input to the banking server and receive an authorization in response to the input being identical to the second one-time password that is received at the text component.

The following description and the annexed drawings set forth in detail certain illustrative aspects of the disclosed subject matter. These aspects are indicative, however, of but a few of the various ways in which the principles of the innovation may be employed. The disclosed subject matter is intended to include all such aspects and their equivalents. Other advantages and distinctive features of the disclosed subject matter will become apparent from the following detailed description of the innovation when considered in conjunction with the drawings.

### BRIEF DESCRIPTION OF DRAWINGS

Non-limiting and non-exhaustive embodiments of the subject disclosure are described with reference to the following figures, wherein like reference numerals refer to like parts throughout the various views unless otherwise specified.

FIG. 1 illustrates an example authentication system in accordance with various aspects described herein;

FIG. 2 illustrates another example authentication system in accordance with various aspects described herein;

FIG. 3 an example input viewing pane in accordance with various aspects described herein;

FIG. 4 an example input viewing pane in accordance with various aspects described herein;

FIG. 5 illustrates a flow diagram showing an exemplary non-limiting implementation for authenticating a device in accordance with various aspects described herein;

FIG. 6 illustrates a flow diagram showing an exemplary non-limiting implementation for authenticating a device in accordance with various aspects described herein;

FIG. 7 is a block diagram representing exemplary non-limiting networked environments in which various non-limiting embodiments described herein can be implemented;

FIG. 8 is a block diagram representing an exemplary non-limiting computing system or operating environment in which one or more aspects of various non-limiting embodiments described herein can be implemented;

FIG. 9 is an isometric view of a device and block diagram according to yet one or more aspects of the present disclosure; and

FIG. 10 is an illustration of an exemplary computer-readable medium comprising processor-executable instructions configured to embody one or more of the provisions set forth herein.

### DETAILED DESCRIPTION

Embodiments and examples are described below with reference to the drawings, wherein like reference numerals are used to refer to like elements throughout. In the following description, for purposes of explanation, numerous specific details in the form of examples are set forth in order to provide a thorough understanding of the various embodiments. It will be evident, however, that these specific details are not necessary to the practice of such embodiments. In other instances, well-known structures and devices are shown in block diagram form in order to facilitate description of the various embodiments.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon such as with a module, for example. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

In addition, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

In consideration of the above-described deficiencies, among other things, various embodiments are provided that authenticate a client or user on a banking server. A banking server, for example, generates and provides at least two one-time passwords that are communicated to a client in different communication channels. The banking server includes a one-time password generator that responds to a user desiring to conduct transaction with an online account. The account is stored, for example, in a database, such as a financial database that has user accounts maintained by a bank computer system that operates the banking server.

In response to a request from the user over a mobile device, the computer system generates control commands to the banking server to generate at least two one-time passwords (OTPs). The banking server communicates to the mobile device of the user the OTPs over different communication pathways or channels. In a first communication pathway, a first OTP of the at least two OTPs is communicated to the mobile device, and in a second communication pathway, a second OTP is also communicated to the mobile device. After receiving the mobile device receives the two passwords, the user is enabled to authenticate the mobile phone with the banking server and conduct transactions remotely.

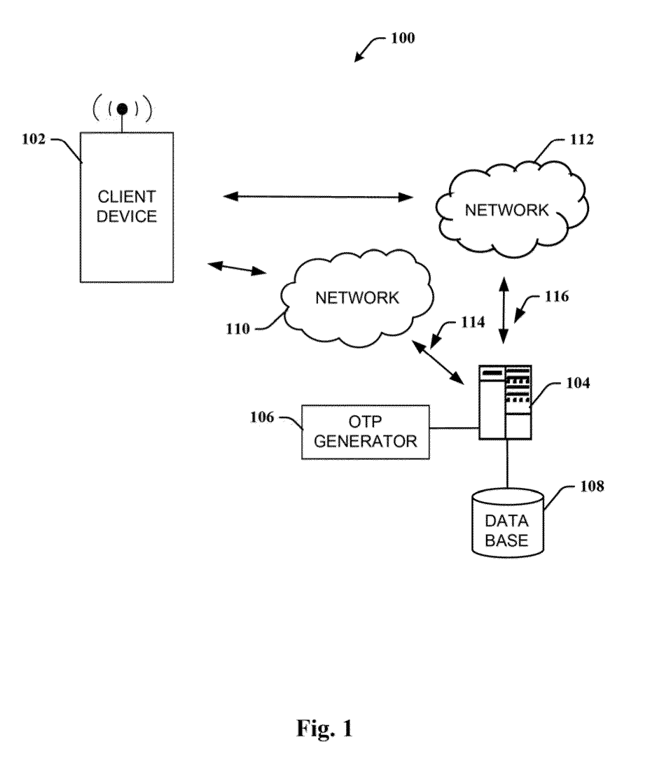

Referring initially to FIG. 1, illustrated is an example system 100 to authenticate a user or client device 102. The system 100 comprises a server 104 such as a banking server that is dedicated to hosting one or more services as a host to clients. The server 104 includes a database 108 having storing capabilities for hosting the various services, and further includes a one-time password generator 106 that is configured to generate OTPs to authenticate clients, devices, mobile devices and the like for conducting banking transactions with accounts at a bank or financial entity. At least two communication pathways 110 and 112 are operatively coupled to the server 104, and are utilized to communicate the OTPs generated by the OTP generator 106 to the client device 102.

In order to use a client device, such as a mobile device (e.g., mobile phone, wireless laptop, personal digital assistant, iPod, and the like) for online banking transactions, a user of the device 102 may need to provide a phone number or some other address of the mobile device to the bank. The phone number or contact address, for example, can be provided during registration of the account, when opening the account, or at some other device registration period, in which a client application is installed on the device 102. Afterwards, the device is authenticated for security.

The system 100 authenticates a client device 102 for online banking or financial transactions. The client device 102 includes a mobile device such as a mobile telephone that has a browser for interacting over the network 112, which includes a wide area network, a local area network or some the network for interfacing with the banking server on a website. The client device 102 includes different channels for communication in order to communicate in various means. For example, the client device 102 communicates via short message services (SMS) according to Global System for Mobile Communications (GSM) series of standards or other standards for other broadcast messaging, via a radio link for calls, Multimedia Messaging Service (MMS), email, internet access, short-range wireless (e.g., infrared, Bluetooth) and the like.

The banking server 102 communicates with the client device 102 in a number of different pathways. For example, in response to the client device signing on to a log-in screen or attempting to access secured content, or some communication request to obtain authentication, the banking server 102 obtains commands to initiate authentication of the client device 102. The OTP generator 106 is configured to generate one-time passwords to be transmitted to the client device 102.

The OTP generator 106 is a dual password generator that generates more than one password concurrently. Each password generated is valid for only one login session or transaction. OTPs avoid a number of shortcomings that are associated with traditional static passwords. For example, OTPs are not vulnerable to replay attacks, and therefore, if a potential intruder manages to record an OTP that was already used to log into a service or to conduct a transaction, he or she will not be able to abuse it since it will be no longer valid. OTP generation algorithms typically make use of randomness, which makes predicting future OTPs by observing previous ones a challenge. Various approaches for the generation of OTPs include approaches based on time-synchronization between the authentication server and the client providing the password (OTPs are valid only for a short period of time), approaches based on using a mathematical algorithm to generate a new password based on the previous password (OTPs are effectively a chain and must be used in a predefined order), and approaches based on using a mathematical algorithm where the new password is based on a challenge (e.g., a random number chosen by the authentication server or transaction details) and/or a counter.

The server 104 communicates at least two OTPs generated by the OTP generator 106 at a time or concurrently to the client device over different communication channels. For example, the network 112 is a wide area network, such as the public internet, and the network 110 is a telephony with a private automatic branch exchange (PABX) or a public switched telephone network (PSTN) having telephony services such as part of General Packet Radio Service (GPRS), Global System for Mobile Communication (GSM), or other mobile technologies that support broadcast messaging such as SMS.

In one embodiment, the server 104 communicates identical OTPs generated by the OTP generator 106 over the communication pathway 116 and the communication pathway 114 to the same client device 102 (e.g., mobile phone). The client device 102 receives the OTP communicated over the network 112 at a web browser. The communication pathway 116 communicatively couples the server 104 to the client device 102 and includes an internet or network pathway for sending an encrypted communication having a first OTP generated. For example, the first OTP generated is provided in a Hypertext Transfer Protocol Secure (HTTPS) to provide encrypted communication and secure identification of the server 104. Some well-known client-based browser applications include NETSCAPE™, INTERNET EXPLORER™, MOZILLA FIREFOX™, OPERA™, or some other suitable browser application. Common to these browser applications is the ability to utilize a Hypertext Transfer Protocol (HTTP) or HTTPS to get, upload or delete web pages and interpret these web pages, which are written in a hyper-text mark-up language (HTML) and/or an Extensible-Mark-up Language (XML). HTTP and HTTPS are well known in the art, as are HTML and XML. HTTP and HTTPS may be used in conjunction with a Transmission Control Protocol/Internet Protocol (TCP/IP) as described in the Open Systems Interconnection (OSI) model, or the TCP protocol stack model, both of which are well known in the art. The practical purpose of the client-based browser application is to enable a user to interact with the application through the display of plain text, and/or interactive dynamic functionality in the form of buttons, text boxes, scroll down bars or other objects contained on one or more web pages constructed using the aforementioned HTML and/or XML.

The communication pathway 114 communicatively couples the server to the client device 102 over network 110 such as a telephony network in a non-encrypted protocol. For example, a second one-time password is communicated in an SMS protocol as a text message to the client device 102. The communication pathway 114, for example, communicates in text messages via an out-of-band communication where the exchange of communications for call control information is in a separate band from the data or voice stream, or on an entirely separate, dedicated channel. Out-of-band authentication includes any technique that allows the identity of the individual originating a transaction to be verified through a channel different from the one the customer is using to initiate the transaction. For example, funds transfer requests, purchase authorizations, or other monetary transactions are sent to the financial institution by the customer either by telephone or by fax. After the institution receives the request, a telephone call is usually made to another party within the company (if a business-generated transaction) or back to the originating individual. The telephoned party is asked for a predetermined word, phrase, or number that verifies that the transaction was legitimate and confirms the dollar amount.

In one embodiment, the server 104 provides at least two OTPs to the client device via an encrypted mode of communication on the communication pathway 116 and a non-encrypted mode of communication on the communication pathway 114. The encrypted mode enables communications in an HTTPS protocol on a TCP/IP connection, for example, to send a first OTP. The non-encrypted mode enables communication in an SMS protocol for text messaging a second OTP on a GPRS or other like connection.

In another embodiment, a clock begins after the confirmation of a received SMS is communicated to the server 104, as indication that user is available and able to access the communication network for reply. If the user did not receive the SMS due to current out of network, the clock does not start. If the user is within the network and a confirmation of a received SMS is retrieved, the OTP is available for access for a predetermined duration of time, before a time out response is communicated to the client device 102.

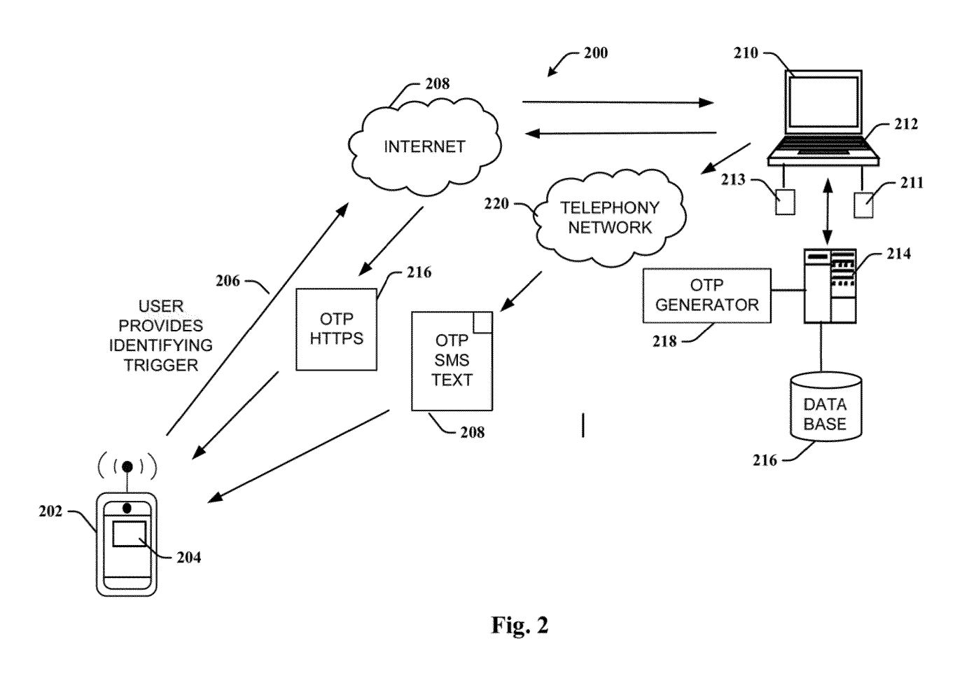

Referring now to FIG. 2, illustrated is an authentication system 200 that authenticates a mobile phone for conducting banking transactions with a user account over a wide area network. A mobile device, such as a mobile telephone 202 initiates a TCP/IP connection 206 over a wide area network 208 to a computer processing device 212. The cell phone 202 has a phone web browser 204 and a banking application for entering an OTP that is received from the banking server 214. A session or connection with the server 214 is first initiated by a trigger or a request for receiving one or more OTPs for conducting online transactions with the user's account via the mobile telephone 202. The trigger may be an identifying trigger from an initial log-in screen, a request to authenticate a user's phone device for a temporary session, or some other initiating event transmitted to the server 214 to indicate a more secure level of communication with a mobile device is requiring authentication.

The computer device 212 hosts a banking server website and generates a log-in screen 210 with a log-in generator 211 for viewing and interacting with a banking server 214. The computer device 212 further includes an authentication component 213 configured to authenticate the mobile telephone 202 by receiving a confirmation or other entry from the mobile phone 202. The computer device 212 is configured to receive a request from the client over the cell phone 202 and generates commands to send to the banking server 214 for generating OTPs. An OTP generator 218 is operatively coupled to the banking server and generates OTPs for access to financial accounts stored in a database 216. At least two OTPs are generated by the OTP generator 218 in response to the commands including a first OTP request and a second OTP request. Each OTP, for example, is generated with one another and communicated concurrently to the client device over different channels.

In one embodiment, each OTP generated is identical to the other and communicated from the banking server in response to commands received by the computer device 212. For example, a first OTP 216 that is generated by the OTP generator is sent to the mobile telephone 202 over the network (e.g., Internet) 208. A second OTP 208 is communicated over a telephony network 220 (e.g., 3G, GPRS, etc.) in a SMS format text message and received as a text at the mobile telephone 202. Each OTP can include one or more numbers, letters, characters, and/or alphanumeric symbols to indicate that a user has obtained a temporary password for conducting an online session for financial transactions with the bank via the browser 204.

The computer device 212 includes a log-in generator 211 that generates a log-in session in HTTPS for interaction by a user of the mobile telephone 202. In response to receiving the OTP text message, a user of the mobile telephone 202 enters the second OTP 208 at a log-in screen 210 that is displayed by the browser 204. Various methods may be implemented for verifying the OTP. Once the server 214 receives the OTP from the user in response to receiving the text 208 with the second OTP, the server then validates a match of the OTP with the OTP sent to the web browser 204. If a match is present, then the server authorizes the client to be authenticated for conducting financial transactions with the phone 202.

The term authentication describes the process of verifying the identity of a person or entity. Authentication is mostly dependent upon the user of the telephone 202 providing valid identification data followed by one or more authentication credentials (factors) to prove their identity, which is verified by the authentication component 213 according to a match of OTPs, for example. Customer identifiers may be a bankcard for ATM usage, or some form of user ID for remote access. An authentication factor (e.g. PIN or password) is unique information linked to a specific customer identifier that is used to verify that identity. In one embodiment, the user of the mobile telephone 202 receives the second OTP and by entering the OTP manually at a screen in the browser a match is determined and the user is allowed to access transactional functionality related to the accounts stored in the data base 216 by the server 214. In addition, a screen such as a graphical user interface (GUI) screen provides controls for the user to enter into an input control (not shown) displayed in the GUI. The input control receives the second OTP manually entered by the user via an input device such as a keyboard, mouse, voice control, touch screen interface or the like. In response to entering the second OTP having been manually entered, another input control may appear or also require entering alongside the second OTP entered. This input control may be a GUI control such as a drop down menu, a tab control, a matching control or some other GUI for displaying the first OTP. Because the first OTP and the second OTP are identical when transmitted from the banking server 214, the banking server 214 is able to authenticate the mobile telephone 202 by determining that the phone 202 received the second OTP and that the client is not using another phone to enter the information and gain access to the server account stored on the data base 216. One or more other mechanisms may also be used such as returning a text from the phone that received the text in conjunction with log-in information at a log-in screen. A clock may have aided in generating the OTPs and therefore if the text is not received or confirmation at the GUI interface screen is not validated the first OTP may become invalidated for confirmation and the second OTP may provide an invalid match or a match that could not be determined.

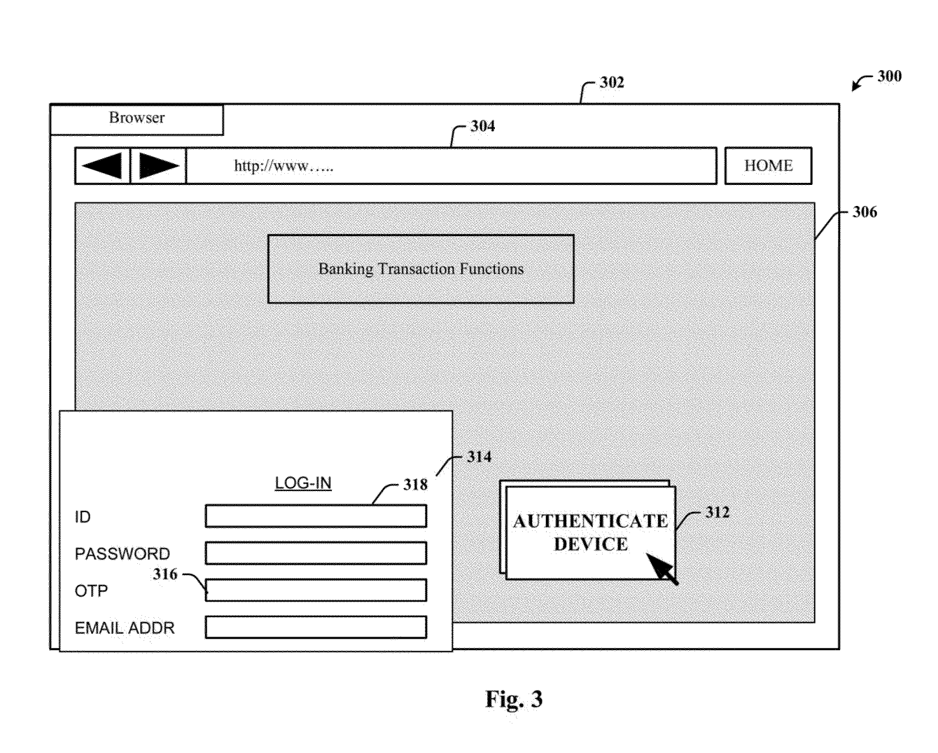

Referring now to FIG. 3, is an example input viewing log-in screen 300 in accordance with various aspects described herein. The pane 300 is generated by a log-in generator 211 for viewing by a web browser in a mobile device (e.g., a mobile phone, laptop, PDA, etc). As discussed previously, the input viewing pane 300 can be associated with a web browser with a financial database hosted on a banking server. The viewing screen 300 may be a GUI generated by utilizing any one of a number of other technologies, such as Asynchronous, JavaScript and XML, Adobe FLASH and the like. Banking functions for financial transactions on a banking website can be accessed via a web browser 302 that includes an address bar 304 (e.g., URL bar, location bar, etc.). The web browser 302 can expose an initiation mechanism 312 to initiate authentication of the mobile device (e.g., 102, 202) having the browser (e.g., 204). After a user has logged into the screen the initiation device may trigger the need to authenticate a mobile device for conduction financial transactions on a network. The devices address, telephone number, etc. may or may not already be stored on the database (108, 216). If the contact phone is new or does not have any address information, the user may enter number or SMS address for receiving an OTP from the banking server.

In one embodiment, the initiation mechanism 312 is not utilized and the trigger event may be from an attempt to conduct an online transaction. In return to either triggering event, the mobile device of the user receives an SMS text message having an OTP from the banking institution or other entity. Concurrently, the web browser may also receive the same OTP communicated to the mobile device.

The screen 300 also includes a log-in screen 314 generated in response to the trigger event (e.g., clicking the initiation mechanism 312, or some other trigger). Once the user of the mobile device receives an OTP via text, the user enters the OTP into the log-in screen 314 as an OTP input at an OTP input field 316. If the OTP is a match, determined by the server (104, 214), then the transaction session is allowed to proceed on the mobile device and the client is provided access to transaction functions related to his or her account. In addition, other information may also be requested at the log-in screen 314 at additional log-in data input fields 318, such as an ID (e.g., a user ID, biometric identifying information, a facial scan, and the like), a password that includes some secret character combination or symbol sequence stored at the bank for recognizing the ID as belonging to certain financial accounts, an email address, and the like.

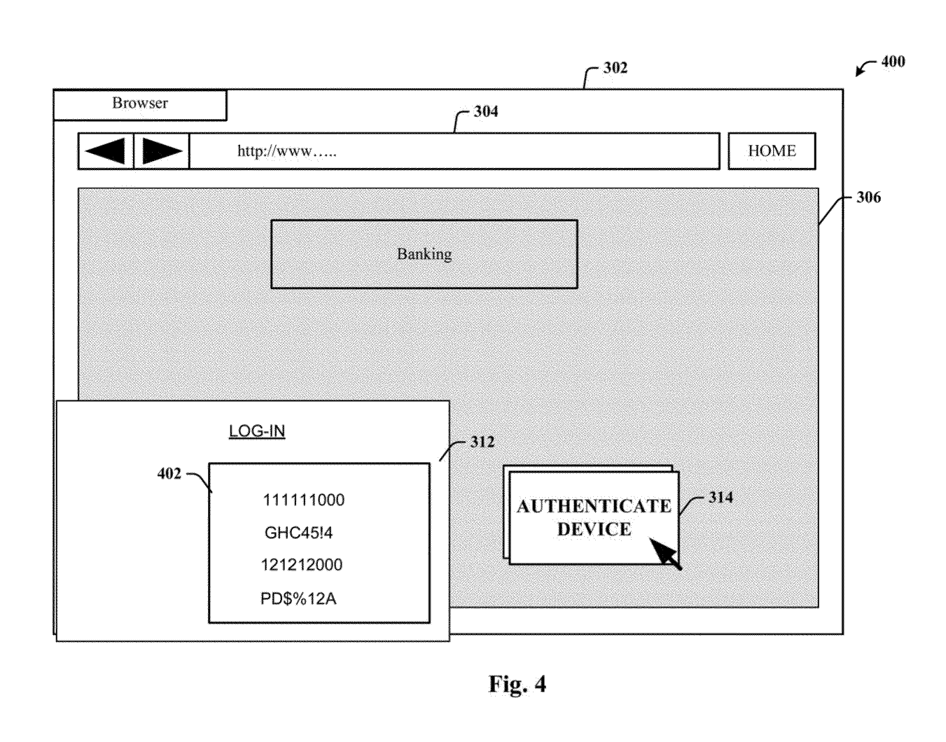

Referring now to FIG. 4, illustrated is an example input viewing log-in screen 400 in accordance with various aspects described herein. Similar components and references are referred to as in FIG. 3. The log-in screen 312 differs in that a drop down menu or confirmation pane 402 is illustrated as a supplemental or substitute for fields requiring manual entry. In one embodiment, a user of a mobile device receiving an OTP via text enters selects the correct confirmation code that matches their text message and is presented within a browser window of the same mobile device. This ensure that the same device, receiving the same OPT is the device being authenticated.

While the methods described within this disclosure are illustrated in and described herein as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

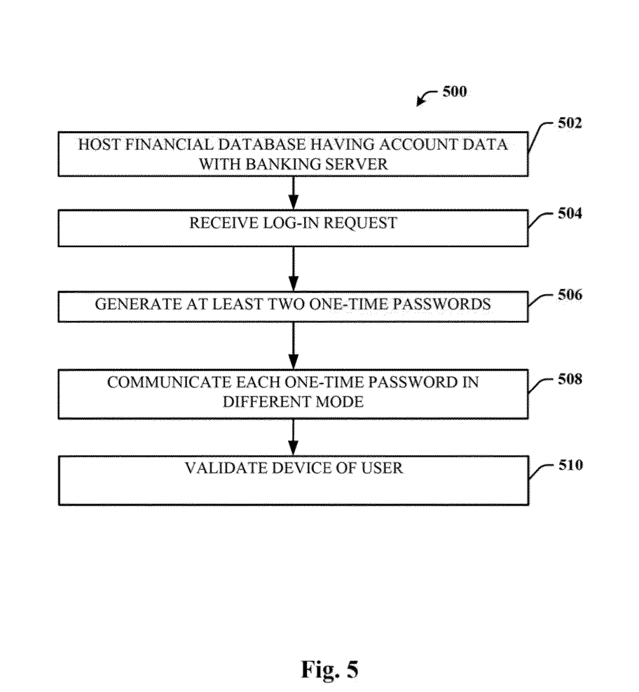

An example methodology 500 for implementing a method for a financial database hosted by a banking server is illustrated in FIG. 5. Reference is made to the figures described above for ease of description. However, the method 500 is not limited to any particular embodiment or example provided within this disclosure.

FIG. 5 illustrates the exemplary method 500 for a system in accordance with aspects described herein. The method 500, for example, provides for authenticating a device of a user for conducting transaction functions related to accounts online. At 502, a financial database is hosted with a banking server that stores financial information related to one or more user accounts. At 504, the banking server receives a log-in request from a device of a user with at least one user account of the one or more user accounts. The log-in request includes any trigger or event based trigger indicating a desire to conduct transactions or perform transaction functions (e.g., transfer money, withdrawal, deposit, request checks, etc.) related to an account stored and maintained on the bank's database. Upon receive a request to conduct banking operations or transaction functions online with a user's device, the banking server processes the request as control commands and initiates a one-time password generator. At 506, at least two one-time passwords are generated and communicated to the user's device (e.g., PC, laptop, mobile phone, etc.).

At 508, the one-time passwords are communicating in different communication modes to the user. For example, a first one-time password is communicated via a secured, encrypted mode such as in an HTTPS protocol, and a second one-time password is communicated from the banking server in an SMS text message. The first one-time password is communicated over a network in a TCP/IP connection to a browser of the user's device, for example, and the second one-time password is communicated over a telephony network or other network to a messaging service of the user's device, such as SMS if the device is a mobile phone or some other message (e.g., email) for a different computing device.

At 510, validating the device of the user is validated. The device, for example is validated at a log-in screen generated by the banking server by authenticating the at least two one-time passwords. The one-time passwords are authenticated according to input provided by the user either manually or by a confirming input by selecting a one-time password received on the device and at a browser of the device. Afterwards, access may be granted to transaction functions related to the at least one user account of the user.

In one embodiment, validating the device of the user at the log-in screen includes authenticating the at least two one-time passwords with an authentication component that determines a match of a first one-time password and a second one-time password of the at least two one-time passwords. In response to the match being determined as identical by the banking server, access to the user's account over the device to perform transactional functions is provided.

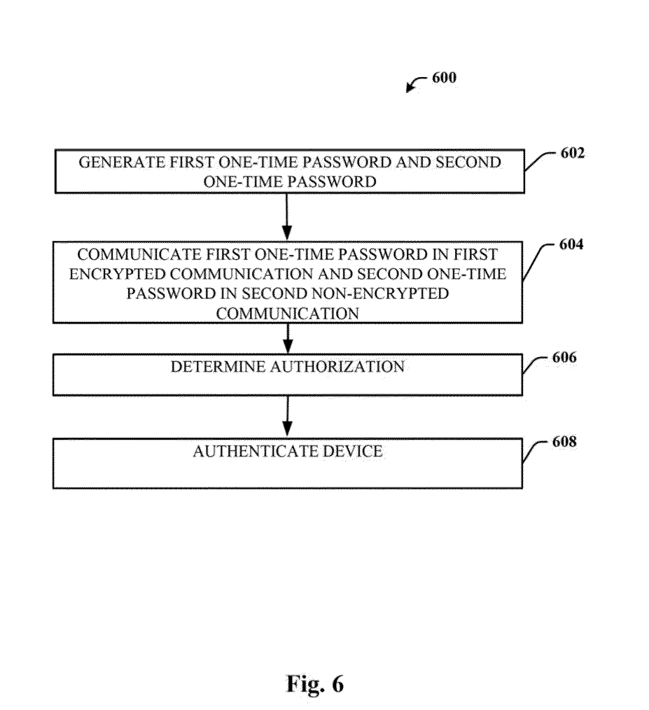

An example methodology 600 for implementing a method for a system that authenticates a user device for online transactions of an account is illustrated in FIG. 6. Reference may be made to the figures described above for ease of description. However, the method 600 is not limited to any particular embodiment or example provided within this disclosure.

The method 600, for example, provides for a system to authenticate mobile devices such as a user's mobile phone by using different levels of encryption over two different communication pathways for transmitting one-time passwords. At 602, a first one-time password and a second one-time password are generated by an OTP generator at a banking server. The one-time passwords may be generated in response to a trigger event, such as a log-in request with a user's mobile device.

At 604, the first one-time password is communicated in a first encrypted communication, such over an encrypted connection having secure protocols (e.g., HTTPS and the like). The first encrypted communication is transmitted over a network to the user's device browser where the OTP is received and may be confirmed and authenticated at the log-in screen. The second one-time password is communicated over a non-encrypted connection or a second non-encrypted communication, such as by a text message to the user's cell phone or mobile device.

At 606, the banking server determines whether to grant an authorization to the mobile device of the user. The authorization may be for a temporary time period or for the specific device by providing a key or recognition ID on the device. Authorization is granted through a log-in screen that may be an initial log-in screen or a secondary log-in screen presented by the web browser in a second screen or window. To authorize the device, a comparison is made by an authorization component that is located on the banking server computing device or can be located on the user device for comparing the first one-time password with an input received from the user at the log-in screen. If the input is the second one-time password, then authorization is granted with respect to the one-time password function. If the input is the same as the first one-time password, authorization may also be granted with respect to the one-time password functionality of the system. The log-in screen may additionally include other identifying data, or password data that operates in conjunction with the one-time password generation and validation operations, such as an email, a user id, a password and the like. At 608, the mobile device is authenticated for online financial transactions to be performed over the network in response to the authorization being granted.

### Exemplary Networked and Distributed Environments

One of ordinary skill in the art can appreciate that the various non-limiting embodiments of the shared systems and methods described herein can be implemented in connection with any computer or other client or server device, which can be deployed as part of a computer network or in a distributed computing environment, and can be connected to any kind of data store. In this regard, the various non-limiting embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the shared shopping mechanisms as described for various non-limiting embodiments of the subject disclosure.

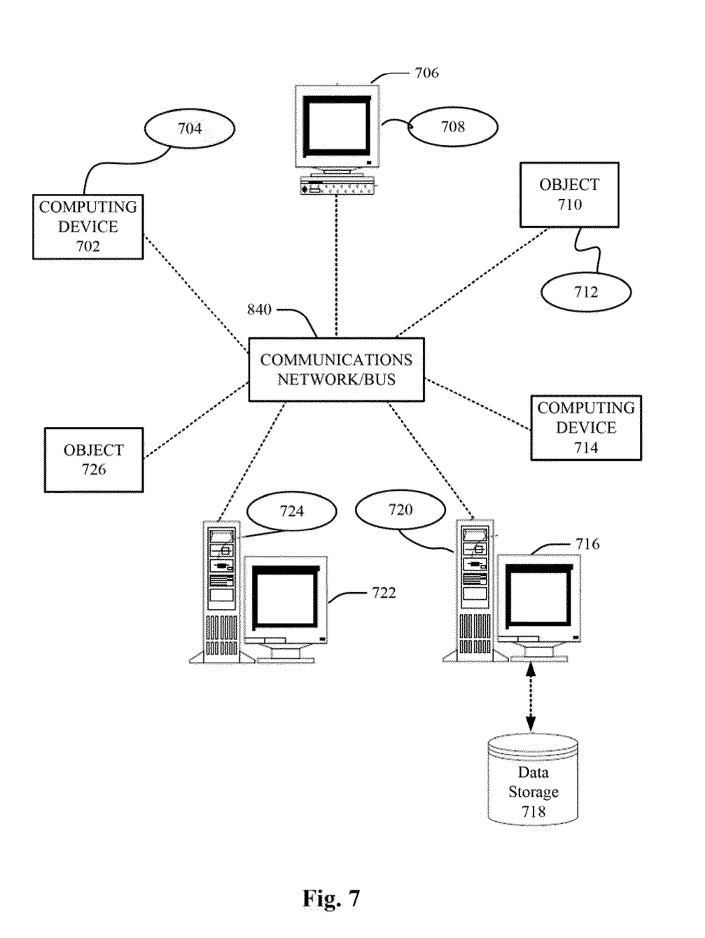

FIG. 7 provides a schematic diagram of an exemplary networked or distributed computing environment. The distributed computing environment comprises computing objects 722, 716, etc. and computing objects or devices 702, 706, 710, 726, 714, etc., which may include programs, methods, data stores, programmable logic, etc., as represented by applications 704, 708, 712, 724, 720. It can be appreciated that computing objects 722, 716, etc. and computing objects or devices 702, 706, 710, 726, 714, etc. may comprise different devices, such as personal digital assistants (PDAs), audio/video devices, mobile phones, MP3 players, personal computers, laptops, etc.

Each computing object 722, 716, etc. and computing objects or devices 702, 706, 710, 726, 714, etc. can communicate with one or more other computing objects 722, 716, etc. and computing objects or devices 702, 706, 710, 726, 714, etc. by way of the communications network 726, either directly or indirectly. Even though illustrated as a single element in FIG. 7, communications network 726 may comprise other computing objects and computing devices that provide services to the system of FIG. 7, and/or may represent multiple interconnected networks, which are not shown. Each computing object 722, 716, etc. or computing object or device 702, 706, 710, 726, 714, etc. can also contain an application, such as applications 704, 708, 712, 724, 720, that might make use of an API, or other object, software, firmware and/or hardware, suitable for communication with or implementation of the shared shopping systems provided in accordance with various non-limiting embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the shared shopping systems as described in various non-limiting embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In client/server architecture, particularly a networked system, a client is usually a computer that accesses shared network resources provided by another computer, e.g., a server. In the illustration of FIG. 7, as a non-limiting example, computing objects or devices 702, 706, 710, 726, 714, etc. can be thought of as clients and computing objects 722, 716, etc. can be thought of as servers where computing objects 722, 716, etc., acting as servers provide data services, such as receiving data from client computing objects or devices 702, 706, 710, 726, 714, etc., storing of data, processing of data, transmitting data to client computing objects or devices 702, 706, 710, 726, 714, etc., although any computer can be considered a client, a server, or both, depending on the circumstances. Any of these computing devices may be processing data, or requesting services or tasks that may implicate the shared shopping techniques as described herein for one or more non-limiting embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 726 or bus is the Internet, for example, the computing objects 722, 716, etc. can be Web servers with which other computing objects or devices 702, 706, 710, 726, 714, etc. communicate via any of a number of known protocols, such as the hypertext transfer protocol (HTTP). Computing objects 722, 716, etc. acting as servers may also serve as clients, e.g., computing objects or devices 702, 706, 710, 726, 714, etc., as may be characteristic of a distributed computing environment.

As mentioned, advantageously, the techniques described herein can be applied to any device where it is desirable to facilitate shared shopping. It is to be understood, therefore, that handheld, portable and other computing devices and computing objects of all kinds are contemplated for use in connection with the various non-limiting embodiments, i.e., anywhere that a device may wish to engage in a shopping experience on behalf of a user or set of users. Accordingly, the below general purpose remote computer described below is but one example of a computing device.

Although not required, non-limiting embodiments can partly be implemented via an operating system, for use by a developer of services for a device or object, and/or included within application software that operates to perform one or more functional aspects of the various non-limiting embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

### Exemplary Computing Device

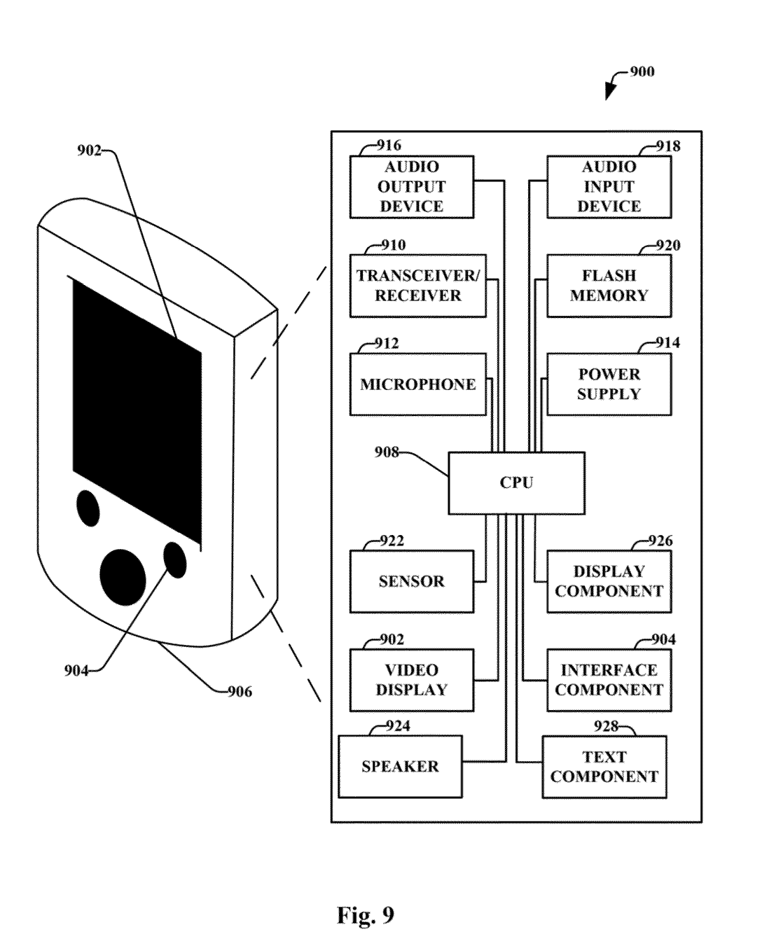

As mentioned, advantageously, the techniques described herein can be applied to a number of various devices for employing the techniques and methods described herein. It is to be understood, therefore, that handheld, portable and other computing devices and computing objects of all kinds are contemplated for use in connection with the various non-limiting embodiments, i.e., anywhere that a device may wish to engage on behalf of a user or set of users. Accordingly, the below general purpose remote computer described below in FIG. 9 is but one example of a computing device.

Although not required, non-limiting embodiments can partly be implemented via an operating system, for use by a developer of services for a device or object, and/or included within application software that operates to perform one or more functional aspects of the various non-limiting embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

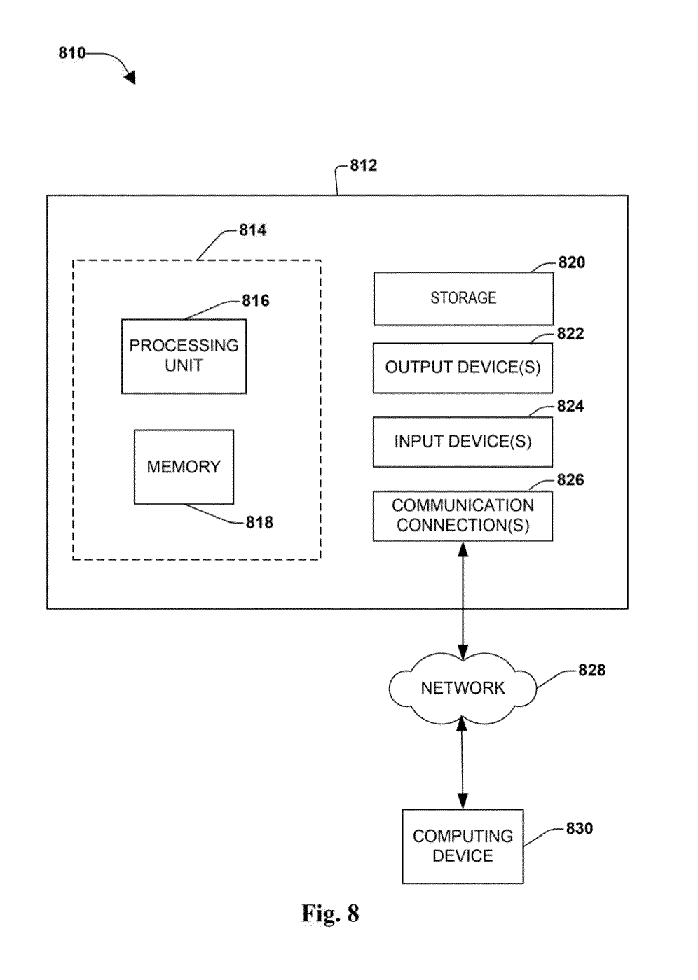

FIG. 8 and the following discussion provide a brief, general description of a suitable computing environment to implement embodiments of one or more of the provisions set forth herein. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 810 comprising a computing device 812 configured to implement one or more embodiments provided herein. In one configuration, computing device 812 includes at least one processing unit 816 and memory 818. Depending on the exact configuration and type of computing device, memory 818 may be volatile (such as RAM, for example), non-volatile (such as ROM, flash memory, etc., for example) or some combination of the two. This configuration is illustrated in FIG. 8 by dashed line 814.

In other embodiments, device 812 may include additional features and/or functionality. For example, device 812 may also include additional storage (e.g., removable and/or non-removable) including, but not limited to, magnetic storage, optical storage, and the like. Such additional storage is illustrated in FIG. 8 by storage 820. In one embodiment, computer readable instructions to implement one or more embodiments provided herein may be in storage 820. Storage 820 may also store other computer readable instructions to implement an operating system, an application program, and the like. Computer readable instructions may be loaded in memory 818 for execution by processing unit 816, for example.

The term “computer readable media” as used herein includes computer storage media. Computer storage media includes volatile and nonvolatile, removable and non-removable media implemented in any method or technology for storage of information such as computer readable instructions or other data. Memory 818 and storage 820 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 812. Any such computer storage media may be part of device 812.

Device 812 may also include communication connection(s) 826 that allows device 812 to communicate with other devices. Communication connection(s) 826 may include, but is not limited to, a modem, a Network Interface Card (NIC), an integrated network interface, a radio frequency transmitter/receiver, an infrared port, a USB connection, or other interfaces for connecting computing device 812 to other computing devices. Communication connection(s) 826 may include a wired connection or a wireless connection. Communication connection(s) 826 may transmit and/or receive communication media.

The term “computer readable media” as used herein includes computer readable storage media and communication media. Computer readable storage media includes volatile and nonvolatile, removable and non-removable media implemented in any method or technology for storage of information such as computer readable instructions or other data. Memory 818 and storage 820 are examples of computer readable storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1012. Any such computer readable storage media may be part of device 812.

Device 812 may also include communication connection(s) 826 that allows device 812 to communicate with other devices. Communication connection(s) 826 may include, but is not limited to, a modem, a Network Interface Card (NIC), an integrated network interface, a radio frequency transmitter/receiver, an infrared port, a USB connection, or other interfaces for connecting computing device 812 to other computing devices. Communication connection(s) 826 may include a wired connection or a wireless connection. Communication connection(s) 826 may transmit and/or receive communication media.

The term “computer readable media” may also include communication media. Communication media typically embodies computer readable instructions or other data that may be communicated in a “modulated data signal” such as a carrier wave or other transport mechanism and includes any information delivery media. The term “modulated data signal” may include a signal that has one or more of its characteristics set or changed in such a manner as to encode information in the signal.

Device 812 may include input device(s) 824 such as keyboard, mouse, pen, voice input device, touch input device, infrared cameras, video input devices, and/or any other input device. Output device(s) 822 such as one or more displays, speakers, printers, and/or any other output device may also be included in device 812. Input device(s) 824 and output device(s) 822 may be connected to device 812 via a wired connection, wireless connection, or any combination thereof. In one embodiment, an input device or an output device from another computing device may be used as input device(s) 824 or output device(s) 822 for computing device 812.

Components of computing device 812 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 812 may be interconnected by a network. For example, memory 818 may be comprised of multiple physical memory units located in different physical locations interconnected by a network.

Those skilled in the art will realize that storage devices utilized to store computer readable instructions may be distributed across a network. For example, a computing device 830 accessible via network 828 may store computer readable instructions to implement one or more embodiments provided herein. Computing device 812 may access computing device 830 and download a part or all of the computer readable instructions for execution. Alternatively, computing device 812 may download pieces of the computer readable instructions, as needed, or some instructions may be executed at computing device 812 and some at computing device 830.

FIG. 9 is an exemplary mobile device, for example, a Personal Data Assistant (PDA) 900 comprising a video display 902, an interface component 904, a housing 906, a CPU 908, a transceiver and/or a receiver 910, a microphone 912, a power supply 914, an audio output device 916, an audio input 918, flash memory 920, various sensors 922, speaker(s) 924, a text component 928. The flash memory 920 utilizing dual bit and single bit memory devices manufactured with an improved buffering system and hybrid arbitration mechanism to improve read/write performance and provide low latency for mobile systems reduce reliability and density by an x decoding circuit capable of reducing the number of sector selects per sector and accessing a particular core sector by concurrently providing an accessing voltage and an inhibiting voltage, per the present invention. The audio input device 918 can be a transducer, for example. The interface component 904 can include a keypad, buttons, dials, pressure keys, and the like. The video display 902 can be a liquid crystal display, a plasma display, an LED display, and the like, for displaying visual data and information. In accordance with another embodiment of the claimed subject matter, the portable device with flash memory 920 comprises cell phones, memory sticks, flash drive devices, video camcorders, voice recorders, USB flash drives, fax machines, flash memory laptops, MP3 players, digital cameras, home video game consoles, hard drives, memory cards (used as solid-state disks in laptops), and the like. The flash memory 920 can include random access memory, read only memory, optical memory, audio memory, magnetic memory, and the like.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

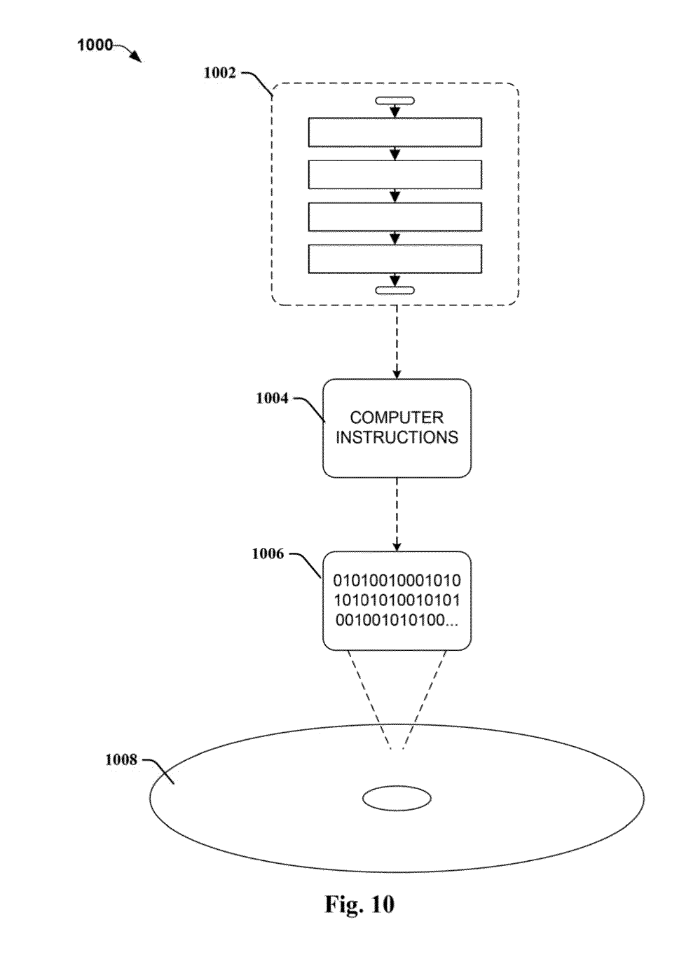

Still another embodiment involves a computer-readable medium comprising processor-executable instructions configured to implement one or more of the techniques presented herein. An exemplary computer-readable medium that may be devised in these ways is illustrated in FIG. 10, wherein the implementation 1000 comprises a computer-readable medium 1008 (e.g., a CD-R, DVD-R, or a platter of a hard disk drive), on which is encoded computer-readable data 1006. This computer-readable data 1006 in turn comprises a set of computer instructions 1004 configured to operate according to one or more of the principles set forth herein. In one such embodiment 1000, the processor-executable instructions 1004 may be configured to perform a method, such as the exemplary methods disclosed herein, for example. In another such embodiment, the processor-executable instructions X may be configured to implement a system, such as the exemplary systems herein, for example. Many such computer-readable media may be devised by those of ordinary skill in the art that are configured to operate in accordance with the techniques presented herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A system comprising:
a banking server including a customer financial database having financial information related to one or more user accounts; and
a one-time password generator operatively coupled to the banking server that is configured to generate one-time passwords, receive control commands from the banking server, and generate a first one-time password and a second one-time password in response to the control commands,
wherein the banking server is configured to communicate the first one-time password over a first communication pathway to a web browser of a mobile device of a user and communicate the second one-time password according to a different communication protocol over a second communication pathway to the mobile device of the user.

2. The system of claim 1, wherein the banking server is configured to communicate the first one-time password over the first communication pathway as an encrypted pathway and the second communication pathway as a non-encrypted pathway.

3. The system of claim 2, wherein the banking server is further configured to communicate the first one-time password over the first communication pathway according to a hypertext transfer protocol secure communication protocol.

4. The system of claim 3, wherein the banking server is further configured to communicate the second one-time password over the second communication pathway according to a short message service communication protocol.

5. The system of claim 4, wherein the one-time password generator is further configured to generate the first one-time password and the second one-time password as identical one-time passwords.

6. The system of claim 1, wherein the banking server is further configured to receive a first one-time password request and a second one-time password request as the control commands to initiate generation of the first one-time password and the second one-time password from the one-time password generator.

7. The system of claim 1, further comprising an authentication component configured to receive a confirmation from the web browser via the first communication pathway of the second one-time password received by the mobile device via the second communication pathway, wherein the mobile device includes a mobile phone device.

8. The system of claim 1, wherein the banking server further comprises a log-in generator configured to generate a log-in screen having input controls that include a one-time password input field and a log-in data input field, wherein the one-time password input field is configured to receive one-time password input from the user.

9. The system of claim 8, wherein the banking server further comprises an authentication component that is configured to receive the first one-time password and the one-time password input from the mobile device and determine whether the first one-time password and the one-time password input from the mobile device match the second one-time password.

10. The system of claim 1, wherein the banking server is further configured to receive the one-time password request that includes a trigger from the user over a network connection to initiate a transaction with respect to a user account of the one or more user accounts.

11. A method, comprising:
receiving, at a banking server that stores financial information related to one or more user accounts, a log-in request from a device of a user with at least one user account of the one or more user accounts;
generating at least two one-time passwords in response to the log-in request;
communicating respective one-time passwords of the at least two one-time passwords in different respective communication modes to the user; and
validating the device of the user including authenticating the at least two one-time passwords and providing access to transaction functions related to the at least one user account of the user.

12. The method of claim 11, wherein the generating the at least two one-time passwords at the banking server in response to the log-in request includes generating the at least two one-time passwords as identical one-time passwords.

13. The method of claim 11, wherein the communicating the respective one-time passwords of the at least two one-time passwords in the different communication modes to the user further includes communicating the at least two one-time passwords to a mobile phone of the user.

14. The method of claim 13, wherein the communicating each one-time password of the at least two one-time passwords in the different communication modes to the user further includes communicating a first one-time password in a first communication mode according to a hypertext transfer protocol secure communication protocol to a web browser of the mobile phone and communicating a second one-time password in a second communication mode according to a short message service communication protocol to the mobile phone.

15. The method of claim 11, wherein the validating the device of the user at the log-in screen generated by the banking server includes authenticating the at least two one-time passwords with an authentication component that determines a match of a one-time password input, a first one-time password and a second one-time password of the at least two one-time passwords, and in response to the match determined as identical, the banking server provides access to the transaction functions.

16. The method of claim 11, wherein the communicating the respective one-time passwords of the at least two one-time passwords in the different communication modes to the user includes communicating a first one-time password of the at least two one-time passwords in an encrypted mode to a web browser of a mobile phone and communicating a second one-time password of the at least two one-time passwords in an unencrypted mode to the mobile phone.

17. The method of claim 16, wherein the validating the device of the user at the log-in screen includes confirming at the web browser that the user received the second one-time password by receiving a one-time password input at an input control of the log-in screen of the mobile phone that matches the second one-time password and the first one-time password.

18. The method of claim 16, wherein the validating the device of the user at the log-in screen includes receiving a confirmation input at the web browser that the user received the second one-time password by receiving the confirmation input at an input control of the log-in screen that has multiple selections with one selection being the first one-time password that matches the second one-time password.

19. A computer readable storage medium comprising computer executable instructions that, in response to execution, cause a computing system to perform operations, comprising:
receiving a log-in request from a mobile device of a user for at least one user account of one or more user accounts at a banking server to access transactional functions related to the at least one user account of the one or more user accounts;
generating a first one-time password and a second one-time password at the banking server in response to the log-in request;
communicating the first one-time password in a first encrypted communication and the second one-time password in a second non-encrypted communication to a mobile device of the user;
determining whether to grant an authorization for the user at a log-in screen generated by the banking server on the mobile device including comparing the first one-time password with an input received from the user at the log-in screen; and
authenticating the mobile device to access the transactional functions related to the at least one user account in response to the authorization being granted.

20. The computer readable storage medium of claim 19, wherein the determining whether to grant the authorization includes receiving the input at the log-in screen that matches the second one-time password.

21. The computer readable storage medium of claim 20, wherein the determining whether to grant the authorization includes determining whether the fist one-time password and the second one-time password identically match.

22. The computer readable storage medium of claim 20, wherein the first encrypted communication includes a hypertext transfer protocol secure communication protocol and the second non-encrypted communication includes a short message service communication protocol.

23. The computer readable storage medium of claim 22, wherein the first encrypted communication and the second non-encrypted communication are concurrently communicated to a mobile phone of the user.

24. The computer readable storage medium of claim 23, wherein the first encrypted communication is communicated to a web browser of the mobile phone and the second non-encrypted communication is communicated to the mobile phone as a text message or voice mail.

25. The computer readable storage medium of claim 24, wherein the first one-time password and the second one-time password are identical and include at least one of numbers, characters, letters, and alpha-numeric symbols.

26. The computer readable storage medium of claim 24, the operations further comprising:
receiving a user identification and a user password and a one-time password input at the log-in screen,
wherein the determining whether to grant the authorization is based on whether the user identification and the user password match with a stored user identification and a stored user password stored at the banking server, and based on whether the one-time password input matches the second one-time password and the first one-time password communicated to the web server of the mobile phone.

27. A system comprising:
means for hosting a banking server with a financial database;
means for receiving a log-in request by a banking server that stores financial information related to one or more user accounts;
means for generating at least two one-time passwords and communicating each of the at least two one-time passwords in a different communication protocol to a mobile phone of a user; and
means for authenticating the mobile phone to access transactional functions related to at least one user account of the one or more user accounts by receiving an input from the user having the second one-time password.

28. The system of claim 27, further comprising:
means for generating a log-in screen having a user identification input control configured to receive a user identification, a user password input control configured to receive a user password and a one-time password input control configured to receive a one-time password input at a web browser on the mobile phone.

29. The system of claim 27, wherein the means for generating the at least two one-time passwords and communicating each of the at least two one-time passwords in the different communication protocol to the mobile phone communicates a first one-time password of the at least two one-time passwords in an encrypted communication protocol and a second one-time password of the at least two one-time passwords in a non-encrypted protocol, wherein the first one-time password and the second one-time password are identical.

30. A method, comprising:
generating a log-in request, by a mobile device, to access at least one user account of one or more user accounts of a banking server and to access transactional functions related to at least one user account of the one or more user accounts;
in response to the log-in request, receiving a first one-time password at a web browser component of the mobile device in a first encrypted communication and receiving a second one-time password at a messaging service of the mobile device in a second non-encrypted communication;
determining whether to grant an authorization for the user at a log-in screen including comparing the first one-time password with an input received from the user at the log-in screen; and
accessing the transactional functions related to the at least one user account in response to the authorization granted based on the input.

31. The method of claim 30, further including receiving the authorization at the input component in response to the input being the second one-time password.

32. The method of claim 30, wherein the receiving the first one-time password includes receiving a hyptertext transfer protocol secure communication and receiving the second one-time password includes receiving a short message service communication.

33. A mobile device, comprising:
an interface component configured to receive trigger data that triggers generation or retrieval of a first one-time password and a second one-time password; and
a display component configured to display information received from a banking server and a one-time password generator;
a web browser component configured to receive the first one-time password in response to the trigger data;
a text component configured to receive the second one-time password in response to the trigger data,
wherein the display component is configured to receive an input from a user of the mobile device, and wherein the interface component is configured to communicate the input to the banking server and receive an authorization in response to the input being identical to the second one-time password that is received at the text component.

34. The mobile device of claim 33, wherein the interface component is configured to receive the authorization at the input component in response to the input being identical to the first one-time password.

35. The mobile device of claim 34, wherein the first one-time password includes a hyptertext transfer protocol secure communication and the second one-time password includes a short message service communication.
